(19) United States
(12) Patent Application Publication
(10) Pub. No.: US 2024/0253709 A1
(43) Pub. Date: Aug. 1, 2024

(54) VEHICLE LOWER BODY STRUCTURE

(71) Applicant: TOYOTA JIDOSHA KABUSHIKI KAISHA, Toyota-shi (JP)

(72) Inventor: Kazuhisa MAEDA, Toyota-shi (JP)

(21) Appl. No.: 18/528,785

(22) Filed: Dec. 5, 2023

(30) Foreign Application Priority Data
Jan. 31, 2023 (JP) 2023-013596

(51) Int. Cl. B62D 27/06; B62D 24/00; B62D 25/02; B62D 25/20; B62D 27/02

(52) U.S. Cl. CPC B62D 27/065; B62D 24/00; B62D 25/025; B62D 25/2036; B62D 27/023

(57) ABSTRACT

A vehicle lower body structure includes: a rocker provided at an outer side, in a vehicle width direction, of a vehicle lower body, the rocker extending in a vehicle front-rear direction; and a floor panel extending in the vehicle width direction and in the vehicle front-rear direction and configuring a floor of a cabin, an end portion, in the vehicle width direction, of the floor panel being mechanically fastened by fasteners to an upper end portion of the rocker in a state in which the end portion of the floor panel overlaps with the upper end portion of the rocker.

### CROSS-REFERENCE TO RELATED APPLICATION

This application claims priority under 35 USC 119 from Japanese Patent Application No. 2023-13596, filed on Jan. 31, 2023, the disclosure of which is incorporated by reference herein in its entirety.

### BACKGROUND

### Technical Field

The present disclosure relates to a vehicle lower body structure.

### Related Art

Japanese Patent Application Laid-open (JP-A) No. H10-147260 discloses a structure in which end portions of a floor panel are joined by spot welding to vertical wall portions of side sills (rockers). Furthermore, in the structure of the above publication, water-tightness in a cabin is ensured by applying a sealant to the joints between the floor panel and the side sills.

### SUMMARY

Introducing structures for circular economies instead of current economic systems is being considered.

However, in a structure in which the floor panel and the rockers are welded to each other as in the structure disclosed in JP-A No. H10-147260, it is difficult to continue to use part of the vehicle because the floor panel and the rockers cannot be separated.

The present disclosure obtains a vehicle lower body structure that can inhibit water ingress into a cabin and allow part of a vehicle to continue to be re-used.

A vehicle lower body structure of a first aspect of the disclosure includes: a rocker provided at an outer side, in a vehicle width direction, of a vehicle lower body, the rocker extending in a vehicle front-rear direction; and a floor panel extending in the vehicle width direction and in the vehicle front-rear direction and configuring a floor of a cabin, an end portion, in the vehicle width direction, of the floor panel being mechanically fastened by fasteners to an upper end portion of the rocker in a state in which the end portion of the floor panel overlaps with the upper end portion of the rocker.

In the vehicle lower body structure of the first aspect, a rocker is provided at an outer side, in the vehicle width direction, of the vehicle lower body, and the rocker extends in the vehicle front-rear direction. Furthermore, a floor panel extends in the vehicle width direction and in the vehicle front-rear direction and configures a floor of a cabin. The end portion, in the vehicle width direction, of the floor panel is mechanically fastened by fasteners to an upper end portion of the rocker in a state in which the end portion of the floor panel overlaps with the upper end portion of the rocker. Because the floor panel and the rocker are mechanically fastened by fasteners to each other in this way, the rocker and the floor panel can be separated by unfastening the fasteners.

Furthermore, because the floor panel is fastened to the upper end portion of the rocker, water ingress into the cabin from the vehicle underside can be inhibited compared with a structure in which the floor panel is fastened to a lower end portion or a middle portion, in a vertical direction, of the rocker.

A vehicle lower body structure of a second aspect of the disclosure is the first aspect, wherein a step portion bent around the rocker is formed at an end, in the vehicle width direction, of the floor panel.

In the vehicle lower body structure of the second aspect, at the time of a side impact to the vehicle, the impact load can be transmitted via the step portion from the rocker to the floor panel.

A vehicle lower body structure of a third aspect of the disclosure is the second aspect, wherein the rocker includes an inner wall portion that extends in a vehicle vertical direction at an inner side, in the vehicle width direction, of the rocker, and an upper wall portion that extends outwardly, in the vehicle width direction, from an upper end of the inner wall portion, and the floor panel includes a base portion that is disposed lower than an upper end of the rocker, a vertical wall portion that extends upwardly along the inner wall portion of the rocker from an outer end, in the vehicle width direction, of the base portion, and an inner upper-wall cover portion that extends outwardly, in the vehicle width direction, from an upper end of the vertical wall portion, the inner upper-wall cover portion being fastened to the rocker in a state in which the inner upper-wall cover portion overlaps with the upper wall portion of the rocker.

In the vehicle lower body structure of the third aspect, the rocker includes the inner wall portion and the upper wall portion, and the floor panel includes the vertical wall portion and the inner upper-wall cover portion. In this way, a step around the rocker is formed in the floor panel by the vertical wall portion and the inner upper-wall cover portion, and the inner upper-wall cover portion overlapping with the upper wall portion of the rocker is fastened to the rocker. Because of this, water ingress into the cabin from the underside of the floor panel can be inhibited without using a sealant compared with a structure in which the floor panel butts against the inner wall portion of the rocker. As a result, it is not necessary to remove a sealant when separating the rocker and the floor panel.

A vehicle lower body structure of a fourth aspect of the disclosure is the third aspect, the vehicle lower body structure further includes an outer panel configuring an outer panel of a vehicle body, wherein a lower end portion of an outer panel is mechanically fastened via fasteners to the rocker, and the floor panel and the outer panel are joined to each other by welding.

In the vehicle lower body structure of the fourth aspect, the outer panel is joined by welding to the floor panel, so water ingress from between the outer panel and the floor panel can be inhibited. Furthermore, the outer panel is mechanically fastened via fasteners to the rocker, so the floor panel and the outer panel can be integrally separated from the rocker by unfastening the fasteners.

A vehicle lower body structure of a fifth aspect of the disclosure is the fourth aspect, wherein the floor panel includes a first flange that extends upwardly from an outer end, in the vehicle width direction, of the inner upper-wall cover portion. The outer panel includes an outer upper-wall cover portion that is fastened to the rocker in a state in which the outer upper-wall cover portion overlaps with the upper wall portion of the rocker, and a second flange that extends upwardly from an inner end portion, in the vehicle width direction, of the outer upper-wall cover portion, and the first flange and the second flange are joined to each other by welding in a state in which the first flange and the second flange overlap with each other.

In the vehicle lower body structure of the fifth aspect, the first flange formed at the floor panel and the second flange formed at the outer panel are joined to each other by welding in a state in which the first flange and the second flange overlap with each other. By welding the flanges to each other in this way, a sufficient welding allowance can be ensured without affecting the places that are fastened with the fasteners.

A vehicle lower body structure of a sixth aspect of the disclosure is the fifth aspect, wherein the rocker includes an outer wall portion that extends downwardly from an outer end, in the vehicle width direction, of the upper wall portion, and the outer panel includes an outer wall cover portion that extends along the outer wall portion of the rocker from the outer upper-wall cover portion and is fastened via fasteners to the outer wall portion of the rocker.

In the vehicle lower body structure of the sixth aspect, the outer panel is fastened at the two surfaces of the upper wall portion and the outer wall portion of the rocker, so the outer panel can be strongly secured to the rocker. Furthermore, the outer wall portion of the rocker is covered by the outer wall cover portion of the outer panel, so design attractiveness can be ensured.

A vehicle lower body structure of a seventh aspect of the disclosure is the sixth aspect, wherein the outer panel includes a projecting portion between the outer upper-wall cover portion and the outer wall cover portion, and the projecting portion projects outward, in the vehicle width direction, away from the rocker.

In the vehicle lower body structure of the seventh aspect, the projecting portion is formed at the outer panel, so compared with a structure in which there is no gap between the outer panel and the rocker, positioning when fastening the outer panel to the rocker can be easily performed.

A vehicle lower body structure of an eighth aspect of the disclosure is the first aspect, wherein the rocker and the floor panel are fastened to each other at multiple places ranging from a front end to a rear end of the rocker, the multiple places being disposed at intervals from each other in the vehicle front-rear direction.

In the vehicle lower body structure of the eighth aspect, the floor panel is fastened to the rocker at the multiple placed ranging from the front end to the rear end of the rocker, so the floor panel can be strongly secured to the rocker.

A vehicle lower body structure of a ninth aspect of the disclosure is any of the first aspect to the eighth aspect, wherein the fasteners include bolts.

In the vehicle lower body structure of the ninth aspect, the floor panel and the rocker can be easily separated by using bolts as the fasteners.

As described above, according to the vehicle lower body structure pertaining to the present disclosure, the vehicle lower body structure can inhibit water ingress into the cabin and allow part of the vehicle to continue to be re-used.

### BRIEF DESCRIPTION OF THE DRAWINGS

FIG. 1 is an exploded perspective view showing main parts of a vehicle to which a vehicle lower body structure pertaining to an embodiment has been applied;

FIG. 2 is a perspective view, as viewed obliquely from below, showing main parts of the vehicle to which the vehicle lower body structure pertaining to the embodiment has been applied;

FIG. 3 is an enlarged sectional view, cut along line 3-3 of FIG. 2, showing main parts of the vehicle lower body structure pertaining to the embodiment;

FIG. 4 is an enlarged sectional view showing main parts of a vehicle lower body structure of comparative example 1; and

FIG. 5 is an enlarged sectional view showing main parts of a vehicle lower body structure of comparative example 2.

### DETAILED DESCRIPTION

A vehicle lower body structure pertaining to an embodiment will now be described with reference to the drawings. It will be noted that arrow UP, arrow FR, and arrow LH appropriately shown in the drawings indicate an upward direction in a vehicle vertical direction, a forward direction in a vehicle front-rear direction, and a vehicle leftward direction (facing the direction of travel), respectively, of a vehicle 10 to which the vehicle lower body structure has been applied. When description is given below simply using the directions of front/rear, upper/lower, and left/right, unless otherwise specified these directions will be understood to indicate front/rear in the vehicle front-rear direction, upper/lower in the vehicle vertical direction, and left/right in the vehicle width direction.

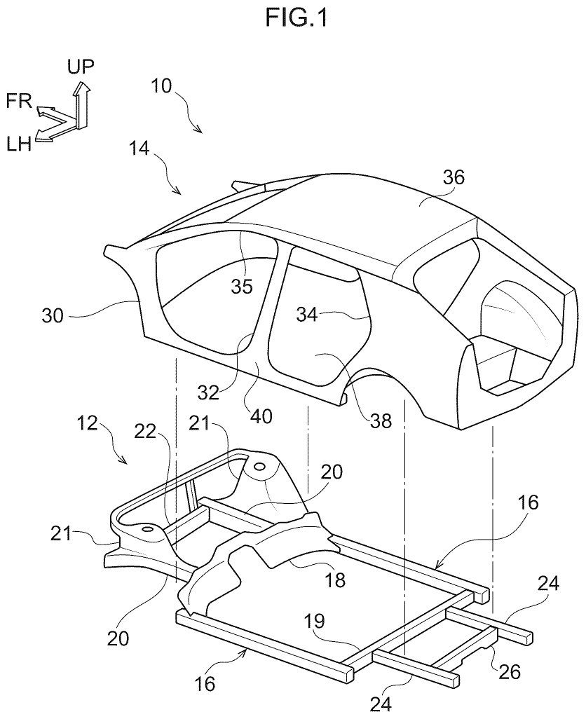

FIG. 1 is an exploded perspective view showing main parts of the vehicle 10 to which the vehicle lower body structure pertaining to the embodiment has been applied. As shown in FIG. 1, the vehicle 10 to which the vehicle lower body structure has been applied is configured to mainly include a lower frame 12 and a body shell 14. The lower frame 12 configures a lower frame of the vehicle 10 and includes rockers 16 that extend in the front-rear direction.

The rockers 16 are provided at outer sides, in the vehicle width direction, of a vehicle lower body and extend in the front-rear direction, and a pair of the rockers 16 are provided on both sides in the width direction. Furthermore, the rockers 16 are each formed in a closed cross-section by extrusion molding or the like. The rockers 16 will be described in detail later.

Front end portions of the pair of rockers 16 are interconnected in the vehicle width direction by a dash cross member 18. Furthermore, connected to the dash cross member 18 are rear end portions of front side members 20. The front side members 20 are provided as a pair on both sides in the vehicle width direction and extend in the front-rear direction. Furthermore, the front side members 20 are each formed in a closed cross-section by extrusion molding or the like, but they may also be configured to have a closed cross-sectional structure by overlapping steel plates on each other.

Front end portions of the pair of front side members 20 are interconnected in the vehicle width direction by a front cross member 22. Furthermore, each of the two front side members 20 is provided with a suspension tower 21.

Rear end portions of the pair of rockers 16 are interconnected in the vehicle width direction by a cross member 19, and connected to the cross member 19 are front end portions of rear side members 24. The rear side members 24 are provided as a pair in the vehicle width direction and extend in the front-rear direction. Furthermore, the rear side members 24 are each formed in a closed cross-section by extrusion molding or the like, but they may also be configured to have a closed cross-sectional structure by overlapping steel plates on each other. Rear portions of the pair of rear side members 24 are interconnected in the vehicle width direction by a rear cross member 26.

The body shell 14 configures a cabin of the vehicle 10 and mainly includes front pillars 30, center pillars 32, rear pillars 34, roof side rails 35, a roof panel 36, a floor panel 38, and outer panels (side member outer panels) 40.

The front pillars 30 extend in the vertical direction at the front end portion of the body shell 14. The center pillars 32 extend in the vertical direction on the vehicle rear side of the front pillar portions 30. The rear pillars 34 extend in the vertical direction on the vehicle rear side of the center pillar portions 32. Furthermore, the front pillars 30, the center pillars 32, and the rear pillars 34 are provided on both sides in the vehicle width direction and have closed cross-sectional structures to function as frames of the body shell 14.

The roof side rails 35 interconnect upper end portions of the front pillars 30, the center pillars 32, and the rear pillars 34 in the front-rear direction and are provided on both sides in the vehicle width direction. The roof panel 36 bridges the left and right roof side rails 35, extends in the vehicle width direction and the front-rear direction, and configures a ceiling of the cabin.

The floor panel 38 is provided at the lower portion of the body shell 14, extends in the vehicle width direction and the front-rear direction, and configures a floor of the cabin. It will be noted that the floor panel 38 includes a center floor panel connected to the rockers 16 and a rear floor panel connected to the rear side members 24.

The outer panels 40 configure outer panels of the body shell 14. Specifically, the outer panels 40 are provided on outer surfaces of the frames of the front pillars 30, outer surfaces of the frames of the center pillars 32, and outer surfaces of the frames of the rear pillars 34. Furthermore, lower portions of the outer panels 40 interconnect lower end portions of the front pillars 30, the center pillars 32, and the rear pillars 34 in the front-rear direction and serve as portions fastened to the rockers 16.

Front side openings are formed by the front pillars 30, the center pillars 32, the roof side rails 35, and the outer panels 40, and these front side openings are closed off by front side doors not shown in the drawings. Furthermore, rear side openings are formed by the center pillars 32, the rear pillars 34, the roof side rails 35, and the outer panels 40, and these rear side openings are closed off by rear side doors not shown in the drawings.

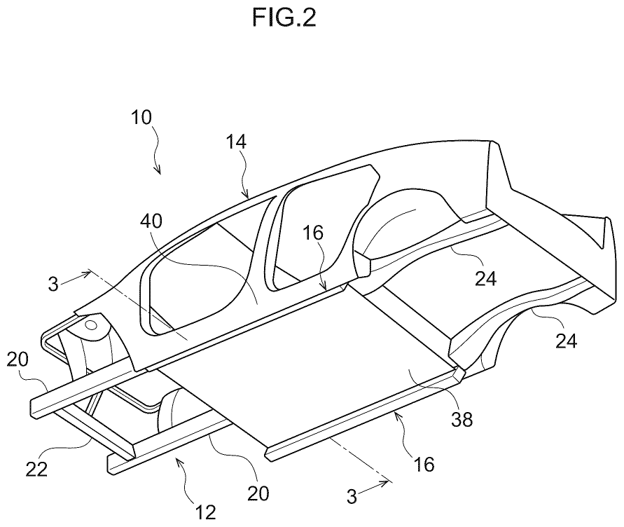

FIG. 2 is a perspective view showing main parts of the vehicle 10 as viewed obliquely from below. As shown in FIG. 2, in a state in which the body shell 14 has been assembled to the lower frame 12, the floor panel 38 is fastened to the left and right rockers 16.

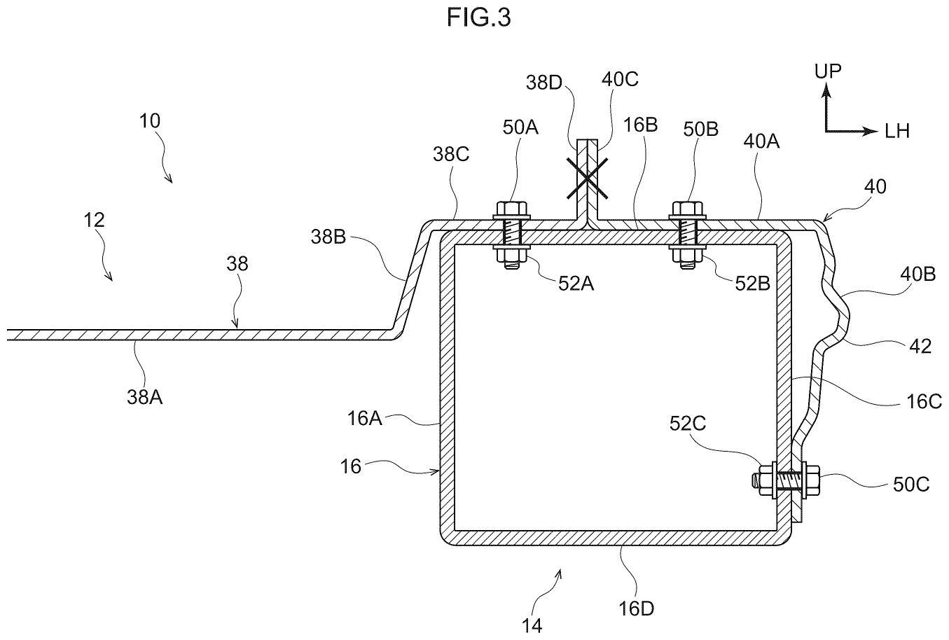

FIG. 3 is an enlarged sectional view, cut along line 3-3 of FIG. 2, showing main parts of the vehicle lower body structure pertaining to the embodiment. As shown in FIG. 3, each of the rockers 16 has a substantially rectangular outer shape as viewed from the front-rear direction and includes an inner wall portion 16A, an upper wall portion 16B, an outer wall portion 16C, and a lower wall portion 16D. It will be noted that although FIG. 3 shows the area around the rocker 16 on the vehicle left side, the same rocker 16 is also provided on the vehicle right side.

The inner wall portion 16A is positioned at an inner side, in the vehicle width direction, of the rocker 16 and extends in the vertical direction and the front-rear direction. The upper wall portion 16B extends outward, in the vehicle width direction, from the upper end of the inner wall portion 16A, and the outer wall portion 16C extends in the vehicle downward direction from the vehicle width direction outer end of the upper wall portion 16B. Furthermore, the lower end of the outer wall portion 16C and the lower end of the inner wall portion 16A are interconnected in the vehicle width direction by the lower wall portion 16D. The upper wall portion 16B of the rocker 16 is provided with two weld nuts 52A, 52B. Specifically, one weld nut 52A is positioned on the vehicle width direction inner side of the vehicle width direction central portion of the upper wall portion 16B and is secured to the surface on the inner side (lower side) of the upper wall portion 16B. Furthermore, the other weld nut 52B is positioned on the vehicle width direction outer side of the weld nut 52A and is secured to the surface on the inner side of the upper wall portion 16B.

The outer wall portion 16C of the rocker 16 is provided with a weld nut 52C. The weld nut 52C is positioned on the lower end portion of the outer wall portion 16C and is secured to the surface on the inner side (right side) of the outer wall portion 16C. The weld nuts 52A, 52B, 52C configure fasteners of the present disclosure.

The floor panel 38 configuring the body shell 14 includes a base portion 38A, a vertical wall portion 38B, and an inner upper-wall cover portion 38C. The base portion 38A has a plate thickness direction coinciding with the vehicle vertical direction, extends in the vehicle width direction and the vehicle front-rear direction, and configures the floor of the cabin. Furthermore, the base portion 38A is positioned lower than the upper end (the upper wall portion 16B) of the rocker 16.

A step portion bent around the rocker 16 is formed in the vehicle width direction end portion of the base portion 38A (the floor panel 38), and this step portion includes the vertical wall portion 38B and the inner upper-wall cover portion 38C. The vertical wall portion 38B extends upwardly along the inner wall portion 16A of the rocker 16 from the vehicle width direction outer end of the base portion 38A. Specifically, the vertical wall portion 38B slopes in such a way that, heading from its lower end to its upper end, the vertical wall portion 38B becomes positioned outward, in the vehicle width direction. The angle formed by the base portion 38A and the vertical wall portion 38B is an obtuse angle.

The inner upper-wall cover portion 38C extends outward, in the vehicle width direction, from the upper end of the vertical wall portion 38B and is fastened to the rocker 16 in a state in which it overlaps with the upper wall portion 16B of the rocker 16. Specifically, the inner upper-wall cover portion 38C extends as far as a central portion, in the vehicle width direction, of the upper wall portion 16B, and an insertion hole is formed in the inner upper-wall cover portion 38C in a position corresponding to the weld nut 52A provided at the rocker 16. A bolt 50A is inserted through the insertion hole from above the inner upper-wall cover portion 38C and screwed into the weld nut 52A, whereby the inner upper-wall cover portion 38C is mechanically fastened to the upper wall portion 16B of the rocker 16.

A first flange portion 38D extends upwardly from the vehicle width direction outer end of the inner upper-wall cover portion 38C, and the first flange portion 38D overlaps with a second flange portion 40C of the outer panel 40 described later.

The outer panel 40 includes an outer upper-wall cover portion 40A that is fastened to the rocker 16 in a state in which the outer upper-wall cover portion 40A overlaps with the upper wall portion 16B of the rocker 16. An inner end, in the vehicle width direction, of the outer upper-wall cover portion 40A butts against the inner upper-wall cover portion 38C of the floor panel 38, and an outer end portion, in the vehicle width direction, of the outer upper-wall cover portion 40A extends outwardly beyond the outer wall portion 16C of the rocker 16.

An insertion hole is formed at the outer upper-wall cover portion 40A in a position corresponding to the weld nut 52B, and a bolt 50B is inserted through the insertion hole from above the outer upper-wall cover portion 40A and screwed into the weld nut 52B, whereby the outer upper-wall cover portion 40A is mechanically fastened to the upper wall portion 16B of the rocker 16.

Furthermore, a second flange portion 40C extends upwardly from the inner end of the outer upper-wall cover portion 40A, and the first flange portion 38D of the floor panel 38 and the second flange portion 40C of the outer panel 40 are joined to each other by spot welding or the like in a state in which they overlap with each other.

Moreover, the outer panel 40 includes an outer wall cover portion 40B that extends downwardly along the outer wall portion 16C of the rocker 16 from the outer upper-wall cover portion 40A. The outer wall cover portion 40B is fastened via a fastener to the outer wall portion 16C of the rocker 16. Specifically, an insertion hole is formed at the outer wall cover portion 40B in a position corresponding to the weld nut 52C, and a bolt 50C is inserted through the insertion hole from the outer side of the outer wall cover portion 40B and screwed into the weld nut 52C, whereby the outer wall cover portion 40B is mechanically fastened to the outer wall portion 16C of the rocker 16.

The rocker 16 and the floor panel 38 are fastened to each other at multiple places at intervals in the vehicle front-rear direction ranging from the front end to the rear end of the rocker 16. Furthermore, the outer panel 40 is, like the floor panel 38, fastened to the rocker 16 at multiple places at intervals in the vehicle front-rear direction. That is, the bolts 50A, 50B, 50C and the weld nuts 52A, 52B, 52C are plurally provided at intervals in the vehicle front-rear direction. The bolts 50A, 50B, 50C configure fasteners of the present disclosure.

Furthermore, the outer panel 40 includes a projecting portion 42 that projects outwardly, in the vehicle width direction, away from the rocker 16 between the outer upper-wall cover portion 40A and the outer wall cover portion 40B.

### (Action)

The action of the present embodiment will be described.

According to the vehicle lower body structure pertaining to the present embodiment, the rocker 16 is provided on the outer side, in the vehicle width direction, of the vehicle lower body, and the rocker 16 extends in the front-rear direction. Furthermore, the floor panel 38 extends in the vehicle width direction and in the front-rear direction and configures the floor of the cabin. The end portion in the vehicle width direction of the floor panel 38 is mechanically fastened by the bolt 50A and the weld nut 52A to the upper wall portion 16B of the rocker 16 in a state in which the end portion of the floor panel 38 overlaps with the rocker 16. Because the floor panel 38 and the rocker 16 are mechanically fastened to each other in this way, the rocker 16 and the floor panel 38 can be easily separated by unfastening the bolt 50A.

Furthermore, because the floor panel 38 is fastened to the upper wall portion 16B of the rocker 16, water ingress from the vehicle underside can be inhibited compared with a structure in which the floor panel 38 is fastened to the lower end portion or a middle portion in the vertical direction of the rocker 16. This effect will be described by way of comparisons with structures of comparative example 1 and comparative example 2.

### Comparative Example 1

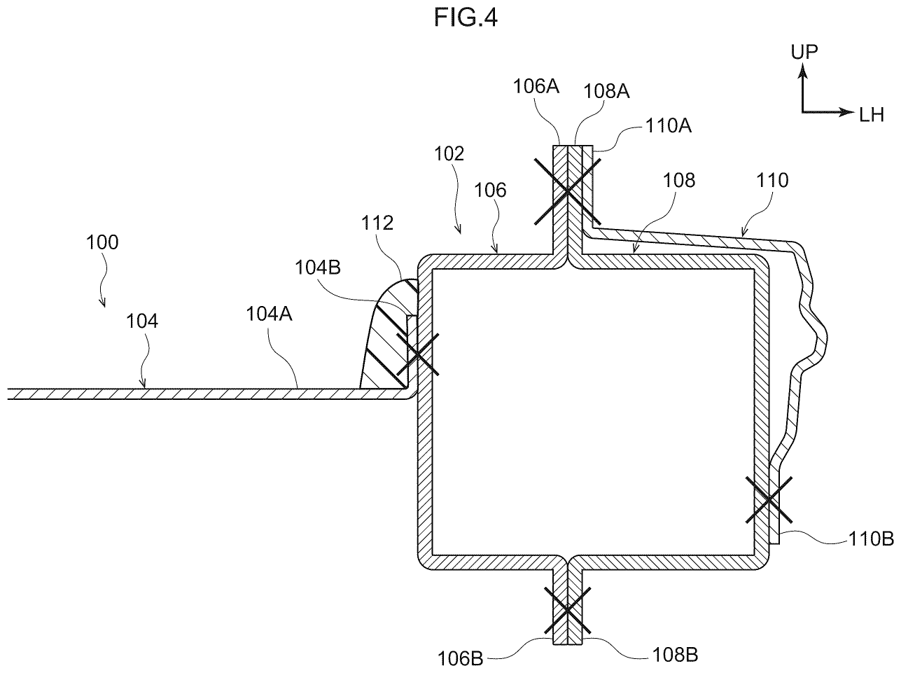

FIG. 4 is an enlarged sectional view showing main parts of a vehicle lower body structure of comparative example 1. As shown in FIG. 4, a vehicle 100 pertaining to comparative example 1 has a vehicle lower body structure with a general monocoque structure.

Specifically, a rocker 102 of the vehicle 100 includes a rocker inner panel 106 on an inner side, in the vehicle width direction, and a rocker outer panel 108 on an outer side, in the vehicle width direction. The rocker inner panel 106 is formed substantially in the shape of a hat whose cross-section as viewed from a front-rear direction is open outward, in the vehicle width direction. At an upper end of the rocker inner panel 106 is formed an upper flange portion 106A that extends upwardly. Furthermore, at a lower end of the rocker inner panel 106 is formed a lower flange portion 106B that extends downwardly.

The rocker outer panel 108 is formed substantially in the shape of a hat whose cross-section as viewed from the front-rear direction is open inward, in the vehicle width direction. At an upper end of the rocker outer panel 108 is formed an upper flange portion 108A that extends upwardly. The upper flange portion 108A overlaps with the upper flange portion 106A of the rocker inner panel 106.

At a lower end of the rocker outer panel 108 is formed a lower flange portion 108B that extends downwardly. The lower flange portion 108B is joined by spot welding or the like to the lower flange portion 106B of the rocker inner panel 106 in a state in which the lower flange portion 108B overlaps with the lower flange portion 106B.

An outer panel 110 covers the rocker 102 from a vehicle width direction outer side. An upper flange portion 110A at an upper end of the outer panel 110 is joined by spot welding or the like to both the upper flange portion 106A of the rocker inner panel 106 and the upper flange portion 108A of the rocker outer panel 108.

A lower flange portion 110B at a lower end of the outer panel 110 is joined by spot welding or the like to a side surface of the rocker outer panel 108.

A floor panel 104 includes a base portion 104A and a flange portion 104B. The base portion 104A is positioned lower than the upper end of the rocker 102 and extends in the vehicle width direction and in the front-rear direction. Furthermore, the flange portion 104B extends upwardly along the rocker 102 from an end portion in the vehicle width direction of the base portion 104A and is joined by spot welding or the like to a side wall of the rocker inner panel 106 in a state in which the flange portion 104B overlaps with the side wall of the rocker inner panel 106. Moreover, a sealant 112 for ensuring water-tightness is applied to the joint portion between the floor panel 104 and the rocker 102.

In comparative example 1 configured as described above, the floor panel 104 and the rocker 102 are welded to each other, so the floor panel 104 and the rocker 102 cannot be easily separated. Furthermore, in order to separate the floor panel 104 and the rocker 102, it is necessary to remove the sealant 112. However, if the sealant 112 is not applied, there may be water ingress from between the floor panel 104 and the rocker 102, so the sealant 112 becomes necessary in a structure where the floor panel 104 butts against the side surface of the rocker 102.

In contrast, in the vehicle 10 including the vehicle lower body structure pertaining to the present embodiment, as shown in FIG. 3, the vehicle width direction end portion of the floor panel 38 is mechanically fastened by the bolt 50A and the weld nut 52A to the upper wall portion 16B of the rocker 16 in a state in which the end portion of the floor panel 38 overlaps with the upper wall portion 16B of the rocker 16. Because of this, water ingress can be inhibited without using a sealant. That is, the vehicle lower body structure pertaining to the present embodiment can inhibit water ingress into the cabin and allow part of the vehicle 10 to continue to be re-used.

### Comparative Example 2

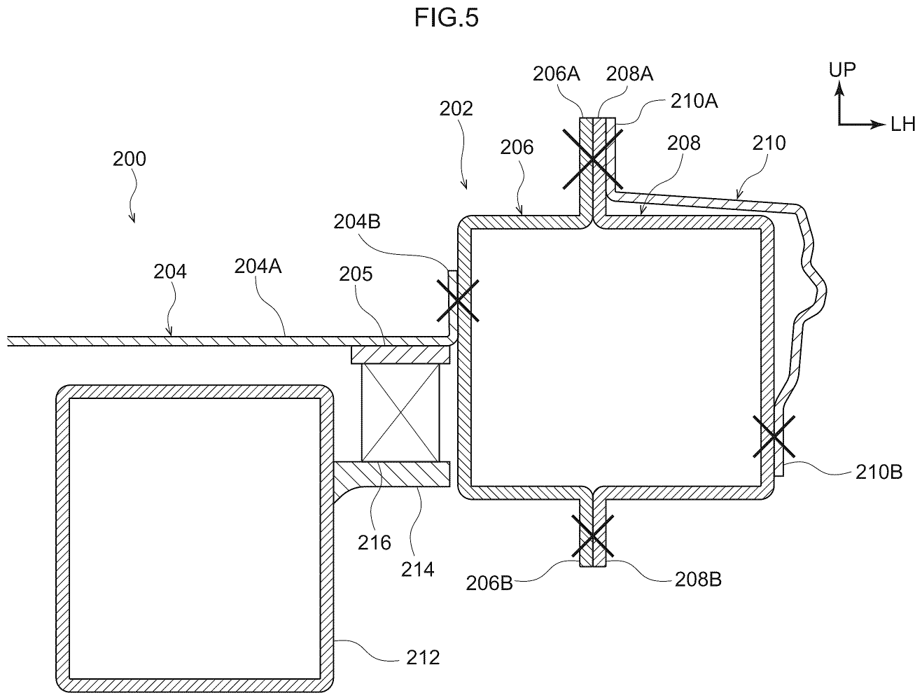

FIG. 5 is an enlarged sectional view showing main parts of a vehicle lower body structure of comparative example 2. As shown in FIG. 5, a vehicle 200 pertaining to comparative example 2 has a vehicle lower body structure with a ladder frame structure.

Specifically, a rocker 202 of the vehicle 200 includes a rocker inner panel 206 at an inner side, in the vehicle width direction, and a rocker outer panel 208 at an outer side, in the vehicle width direction. The rocker inner panel 206 is formed substantially in the shape of a hat whose cross-section as viewed from a vehicle front-rear direction is open outward, in the vehicle width direction. At an upper end of the rocker inner panel 206 is formed an upper flange portion 206A that extends upwardly. Furthermore, at a lower end portion of the rocker inner panel 206 is formed a lower flange portion 206B that extends downwardly.

The rocker outer panel 208 is formed substantially in the shape of a hat whose cross-section as viewed from the vehicle front-rear direction is open inward, in the vehicle width direction. At an upper end of the rocker outer panel 208 is formed an upper flange portion 208A that extends upwardly. The upper flange portion 208A overlaps with the upper flange portion 206A of the rocker inner panel 206.

At a lower end of the rocker outer panel 208 is formed a lower flange portion 208B that extends downwardly. The lower flange portion 208B is joined by spot welding or the like to the lower flange portion 206B of the rocker inner panel 206 in a state in which the lower flange portion 208B overlaps with the lower flange portion 206B.

An outer panel 210 covers the rocker 202 from an outer side, the vehicle width direction. An upper flange portion 210A at an upper end of the outer panel 210 is joined by spot welding or the like to both the upper flange portion 206A of the rocker inner panel 206 and the upper flange portion 208A of the rocker outer panel 208.

A lower flange portion 210B at a lower end of the outer panel 210 is joined by spot welding or the like to a side surface of the rocker outer panel 208.

A floor panel 204 includes a base portion 204A and a flange portion 204B. The base portion 204A is positioned lower than the upper end of the rocker 202 and extends in the vehicle width direction and in the vehicle front-rear direction. Furthermore, the flange portion 204B extends upwardly along the rocker 202 from an end in the vehicle width direction of the base portion 204A and is joined by spot welding or the like to a side wall of the rocker inner panel 206 in a state in which the flange portion 204B overlaps with the side wall of the rocker inner panel 206. Moreover, a reinforcement frame 205 is provided at a lower surface of an end in the vehicle width direction of the floor panel 204.

A vehicle body including the rocker 202, the floor panel 204, and the outer panel 210 configured as described above is mounted on a frame 212. Specifically, a side frame 212 is disposed under the floor panel 204, and the side frame 212 extends in the vehicle front-rear direction.

The side frame 212 is provided as a pair on the left and right, and plural cross members (not shown in the drawings) bridge the left and right side frames 212 to configure a ladder-like frame.

A mounting bracket 214 is secured to an outer side surface, in the vehicle width direction, of the side frame 212, and the floor panel 204 and the reinforcement frame 205 are supported on the mounting bracket 214 via a body mount 216.

In this way, in the vehicle 200 with the ladder frame structure, the vehicle body including the rocker 202, the floor panel 204, and the outer panel 210 is mounted on the side frame 212. The side frame 212 and the rocker 202 form a frame whose weight and cost are greater than those of the monocoque structure of the present embodiment. Furthermore, in the vehicle 200 of comparative example 2, when separating the rocker 202 and the floor panel 204, it is first necessary to separate the vehicle body including the rocker 202 from the side frame 212.

In contrast, in the vehicle 10 including the vehicle lower body structure pertaining to the present embodiment, by attaching the body shell 14 to the lower frame 12, they function as a monocoque structure, so they do not require a separate frame.

Furthermore, in the vehicle 10 of the present embodiment, it becomes possible to replace just the body shell 14 not including the rocker 16 by separating the lower frame 12 and the body shell 14, and costs required for replacement and the like can be reduced.

In particular, in the vehicle lower body structure pertaining to the present embodiment, as shown in FIG. 3, the rocker 16 includes the inner wall portion 16A and the upper wall portion 16B, and the floor panel 38 includes the vertical wall portion 38B and the inner upper-wall cover portion 38C. In this way, a step along the rocker 16 is formed in the floor panel 38 by the vertical wall portion 38B and the inner upper-wall cover portion 38C, and the inner upper-wall cover portion 38C overlapping with the upper wall portion 16B of the rocker 16 is fastened to the rocker 16. Because of this, water ingress into the cabin from the underside of the floor panel 38 can be inhibited without using a sealant compared with a structure in which the floor panel 38 butts against the inner wall portion 16A of the rocker 16. As a result, it is not necessary to remove a sealant when separating the rocker 16 and the floor panel 38.

Furthermore, in the present embodiment, the outer panel 40 is joined by welding to the floor panel 38, so water ingress from between the outer panel 40 and the floor panel 38 can be inhibited. Furthermore, the outer panel 40 is mechanically fastened via the bolts 50B, 50C and the weld nuts 52B, 52C to the rocker 16, so the floor panel 38 and the outer panel 40 can be integrally separated from the rocker 16 by unfastening these fasteners.

Moreover, in the present embodiment, the first flange portion 38D formed at the floor panel 38 and the second flange portion 40C formed at the outer panel 40 are joined to each other by welding in a state in which they overlap with each other. By welding the flange portions to each other in this way, a sufficient welding allowance can be ensured without affecting the places that are fastened with the fasteners.

Furthermore still, in the present embodiment, the outer panel 40 is fastened at the two surfaces of the upper wall portion 16B and the outer wall portion 16C of the rocker 16, so the outer panel 40 can be strongly secured to the rocker 16. Furthermore, the outer wall portion 16C of the rocker 16 is covered by the outer wall cover portion 40B of the outer panel 40, so design attractiveness can be ensured.

Furthermore, in the present embodiment, the projecting portion 42 is formed at the outer panel 40, so compared with a structure in which there is no gap between the outer panel 40 and the rocker 16, positioning when fastening the outer panel 40 to the rocker 16 can be easily performed.

In particular, the floor panel 38 is fastened to the rocker 16 ranging from the front end to the rear end of the rocker 16, so the floor panel 38 can be strongly secured to the rocker 16.

A vehicle lower body structure pertaining to an embodiment has been described above, but the present disclosure can of course be implemented in various ways without departing from the scope of the present disclosure. In the above embodiment, the first flange portion 38D of the floor panel 38 and the second flange portion 40C of the outer panel 40 extend upwardly, but they are not limited to this. For example, the first flange portion 38D may extend in the vehicle width direction along the upper wall portion 16B of the rocker 16, and the second flange portion 40C of the outer panel 40 may overlap with, and be welded to, the upper surface of the first flange portion 38D. In this case, the direction in which the flange portions overlap with each other is in the vehicle vertical direction, so a step is formed between the outer upper-wall cover portion 40A and the second flange portion 40C of the outer panel 40. In other words, the first flange portion 38D is welded in a state in which it is inserted between the outer panel 40 and the rocker 16, so water ingress can be inhibited.

Furthermore, in the above embodiment, the rocker 16 is formed in a closed cross-section without flanges by extrusion molding or the like, but it is not limited to this. For example, the rocker may also be configured by welding together flanges of two steel plates of a rocker inner panel and a rocker outer panel. In this case, the first flange portion 38D of the floor panel 38 and the second flange portion 40C of the outer panel 40 may overlap with and be welded to each other in a state in which they extend higher than the flange portions of the rocker. Furthermore, the first flange portion 38D and the second flange portion 40C may be mechanically fastened to the flange portions of the rocker using bolts and nuts or the like. In any case, the floor panel 38 and the outer panel 40 can be easily separated from the rocker.

Moreover, in the above embodiment, bolts and weld nuts are used as the fasteners, but the fasteners are not limited to this, and other fasteners may also be employed. For example, fasteners such as rivets may be used for at least some of the fasteners.

What is claimed is:

1. A vehicle lower body structure, comprising:
a rocker provided at an outer side, in a vehicle width direction, of a vehicle lower body, the rocker extending in a vehicle front-rear direction; and
a floor panel extending in the vehicle width direction and in the vehicle front-rear direction and configuring a floor of a cabin, an end portion, in the vehicle width direction, of the floor panel being mechanically fastened by fasteners to an upper end portion of the rocker in a state in which the end portion of the floor panel overlaps with the upper end portion of the rocker.

2. The vehicle lower body structure of claim 1, wherein a step portion bent around the rocker is formed at an end, in the vehicle width direction, of the floor panel.

3. The vehicle lower body structure of claim 2, wherein:
the rocker includes an inner wall portion that extends in a vehicle vertical direction at an inner side, in the vehicle width direction, of the rocker, and an upper wall portion that extends outwardly, in the vehicle width direction, from an upper end of the inner wall portion, and
the floor panel includes a base] portion that is disposed lower than an upper end of the rocker, a vertical wall portion that extends upwardly along the inner wall portion of the rocker from an outer end, in the vehicle width direction, of the base portion, and an inner upper-wall cover portion that extends outwardly from an upper end of the vertical wall portion, the inner upper-wall cover portion being fastened to the rocker in a state in which the inner upper-wall cover portion overlaps with the upper wall portion of the rocker.

4. The vehicle lower body structure of claim 3, further comprising an outer panel configuring an outer panel of a vehicle body, wherein:
a lower end portion of the outer panel is mechanically fastened via fasteners to the rocker, and
the floor panel and the outer panel are joined to each other by welding.

5. The vehicle lower body structure of claim 4, wherein:
the floor panel includes a first flange that extends upwardly from an outer end, in the vehicle width direction, of the inner upper-wall cover portion,
the outer panel includes an outer upper-wall cover portion that is fastened to the rocker in a state in which the outer upper-wall cover portion overlaps with the upper wall portion of the rocker, and a second flange that extends upwardly from an inner end, in the vehicle width direction, of the outer upper-wall cover portion, and
the first flange and the second flange are joined to each other by welding in a state in which the first flange and the second flange overlap with each other.

6. The vehicle lower body structure of claim 5, wherein:
the rocker includes an outer wall portion that extends downwardly from an outer end, in the vehicle width direction, of the upper wall portion, and
the outer panel includes an outer wall cover portion that extends from the outer upper-wall cover portion along the outer wall portion of the rocker and the outer wall cover portion is fastened via fasteners to the outer wall portion of the rocker.

7. The vehicle lower body structure of claim 6, wherein the outer panel includes a projecting portion between the outer upper-wall cover portion and the outer wall cover portion, and the projecting portion projects outward, in the vehicle width direction, away from the rocker.

8. The vehicle lower body structure of claim 1, wherein the rocker and the floor panel are fastened to each other at multiple places ranging from a front end to a rear end of the rocker, the multiple places being disposed at intervals from each other in the vehicle front-rear direction.

9. The vehicle lower body structure of claim 1, wherein the fasteners include bolts.

10. The vehicle lower body structure of claim 4, wherein the fasteners include bolts.

11. The vehicle lower body structure of claim 6, wherein the fasteners include bolts.
